(19) United States
(12) Patent Application Publication
(10) Pub. No.: US 2013/0214623 A1
(43) Pub. Date: Aug. 22, 2013

(54) SWITCHED RELUCTANCE MOTOR

(71) Applicants: Hae Jun YANG, Suwon (KR); Ki Young LEE, Suwon (KR); Sung Tai JUNG, Suwon (KR); Hyung Joon KIM, Suwon (KR)

(72) Inventors: Hae Jun YANG, Suwon (KR); Ki Young LEE, Suwon (KR); Sung Tai JUNG, Suwon (KR); Hyung Joon KIM, Suwon (KR)

(73) Assignee: SAMSUNG ELECTRO-MECHANICS CO., LTD., Gyunggi-do (KR)

(21) Appl. No.: 13/592,154

(22) Filed: Aug. 22, 2012

(30) Foreign Application Priority Data
Aug. 22, 2011 (KR) 10-2011-0083596

(51) Int. Cl. H02K 3/12

(52) U.S. Cl. CPC H02K 3/12
USPC 310/46

(57) ABSTRACT

Disclosed herein is a switched reluctance motor including: a salient pole type rotor provided with a plurality of salient poles; and a stator including a stator body provided with a plurality of salient poles facing the rotor and a plurality of auxiliary slots disposed between the salient poles, a plurality of phase windings formed by winding coils around the salient poles, and a plurality of electromagnets formed by winding coils in the auxiliary slots, wherein magnetic fluxes generated due to excitation of the phase windings interact with magnetic force generated from the electromagnets, such that a magnetic flux amount may increase and torque density may be improved, and an intersection line is not generated in the magnetic fluxes generated due to the excitation of the phase windings.

### CROSS REFERENCE TO RELATED APPLICATION

This application claims the benefit of Korean Patent Application No. 10-2011-0083596, filed on Aug. 22, 2011, entitled “Mechanically Commutated Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

In a general switched reluctance motor, both of a stator and a rotor have a salient pole type magnetic structure. In addition, the stator has a concentrated type coil wound therearound, and the rotor is configured only of an iron core without any type of excitation device (a winding, a permanent magnet, or the like), such that a competitive cost is excellent. Further, a speed changeable switched reluctance motor stably generates a continuous torque with the aid of a converter using a power semiconductor and a position sensor and is easily controlled to be appropriate for performance required in each application.

In the case of various alternate current (AC) motors (an induction motor, a permanent magnet synchronous motor, or the like) and a brushless direct current (DC) motor, when a significant improvement in performance is required due to the passage of time after design of one electromagnetic field structure is completed, the electromagnetic field structure should be re-designed as a new electromagnetic field structure. Otherwise, there is no way except for a simple design change replacing a high cost material such as steel, a permanent magnet, or the like, which is not an efficient design. The switched reluctance motor also has the above-mentioned problem.

More specifically, a switched reluctance motor according to the prior art includes a rotor and a stator including salient poles. In addition, coils are wound around the salient poles to form a phase winding. When a current is applied to the phase winding, a magnetic field is generated and attractive force is generated between the salient pole of the stator and the rotor, such that the rotor rotates.

In addition, a plurality of salient poles are formed in the stator, the coils are wound around the plurality of salient poles to form a plurality of phase windings, and each of the plurality of phase windings is excited to generate a torque, thereby rotating the rotor. However, in the switched reluctance motor according to the prior art, since only the windings are excited to generate the torque, torque density, efficiency, and the like, are limited. In addition, when the switched reluctance motor according to the prior art is implemented as a switched reluctance motor having a plurality of phases, core loss increases due to intersection of magnetic fluxes.

### SUMMARY OF THE INVENTION

The present invention has been made in an effort to provide a switched reluctance motor in which a plurality of phase windings are formed by winding coils around salient poles of a stator and electromagnets are formed by winding coils in auxiliary slots between the phase windings, wherein magnetic fluxes generated due to excitation of the phase windings interact with magnetic force generated from the electromagnets, such that a magnetic flux amount may increase and torque density may be improved, and an intersection line is not generated in the magnetic fluxes generated due to the excitation of the phase windings, such that core loss may be reduced.

According to a preferred embodiment of the present invention, there is provided a switched reluctance motor including: a salient pole type rotor provided with a plurality of salient poles; and a stator including a stator body provided with a plurality of salient poles facing the rotor and a plurality of auxiliary slots disposed between the salient poles, a plurality of phase windings formed by winding coils around the salient poles, and a plurality of electromagnets formed by winding coils in the auxiliary slots.

The plurality of auxiliary slots may be slots formed to be directed from an inner diameter of the stator body toward an outer diameter thereof or from the outer diameter thereof toward the inner diameter thereof.

Directions in which the coils are wound in the plurality of auxiliary slots may intersect with each other and be repeated.

Directions in which the coils are wound around the plurality of salient poles of the stator may intersect with each other and be repeated.

The electromagnets may be disposed so that magnetic force is generated in a direction corresponding to those of magnetic fluxes generated in the phase windings.

An intersection line may not be generated in magnetic fluxes generated due to excitation of the phase windings.

Six salient poles of the rotor may be formed at equipitch in a circumferential direction of the rotor, four salient poles of the stator body may be formed at equipitch in the circumferential direction of the rotor body, the phase winding may be formed as a two-phase winding formed by winding the coils around the salient poles, and four auxiliary slots may be formed between the salient poles.

Ten salient poles of the rotor may be formed at equipitch in a circumferential direction of the rotor, six salient poles of the stator body corresponding to the salient poles of the rotor may be formed at equipitch in a circumferential direction of the stator body, the phase winding may be formed as a three-phase winding formed by winding the coils around the salient poles, and six auxiliary slots may be formed between the salient poles.

### BRIEF DESCRIPTION OF THE DRAWINGS

FIG. 1 is a schematic configuration view of a switched reluctance motor according to a first preferred embodiment of the present invention;

FIG. 2 is a schematic use state view showing magnetic flux distribution at the time of excitation of a first-phase winding in the switched reluctance motor shown in FIG. 1;

FIG. 3 is a schematic use state view showing magnetic flux distribution at the time of to excitation of a second-phase winding in the switched reluctance motor shown in FIG. 1; and

FIG. 4 is a schematic configuration view of a switched reluctance motor according to a second preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a switched reluctance motor according to preferred embodiments of the present invention will be described with reference to the accompanying drawings.

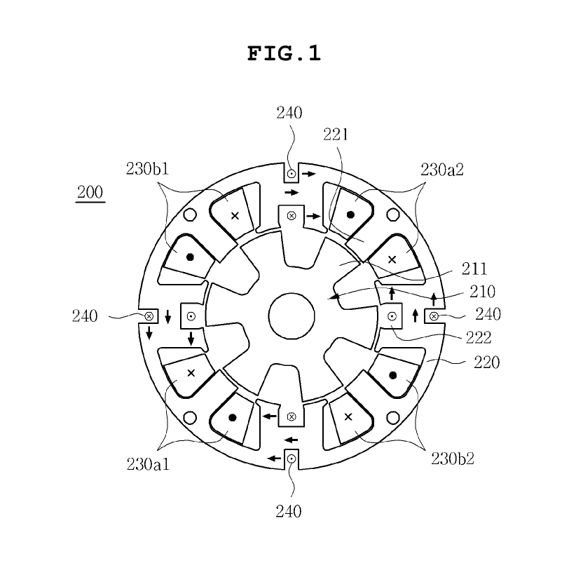

FIG. 1 is a schematic configuration view of a switched reluctance motor according to a first preferred embodiment of the present invention. As shown, the switched reluctance motor 200 includes a rotor 210 and a stator, wherein the rotor 210 rotates by electromagnetic force with the stator.

More specifically, the rotor 210 is rotatably disposed in an inner side of the stator and is implemented as a salient pole type rotor including a plurality of salient poles 211 formed at an outer peripheral portion thereof in a radial direction. In addition, six salient poles 211 of the rotor are formed at equipitch in a circumferential direction of the rotor. Further, the stator includes a stator body 220, phase windings 230a1, 230a2, 230b1, and 230b2, and electromagnets 240.

In addition, the stator body 220 is provided with a plurality of salient poles 221 protruded inwardly in the radial direction so as to face the rotor and disposed at equipitch in the circumferential direction and a plurality of auxiliary slots 222 formed between the salient poles 221.

Further, coils are wound around the plurality of salient poles 221 of the stator body 220 so as to enclose the plurality of salient poles 221 to thereby form the phase windings 230a1, 230a2, 230b1, and 230b2. In addition, directions in which the coils are wound around the plurality of salient poles 221 of the stator intersect with each other and are repeated. Further, the plurality of auxiliary slots 222 are slots formed to be directed from an inner diameter of the stator body toward an outer diameter thereof or from the outer diameter thereof toward the inner diameter thereof in the radial direction thereof so that the coils are wound in the radial direction of the stator body 220, that is, around the inner diameter and the outer diameter of the stator body, in order to be implemented as the electromagnets.

In addition, the electromagnets 240 are to improve torque density by adding their magnetic force to magnetic fluxes generated due to excitation of the phase windings 230a1, 230a2, 230b1, and 230b2. As described above, the coils are wound in the auxiliary slots 222 between the phase windings 230a1, 230a2, 230b1, and 230b2 in the radial direction of the stator, such that the electromagnets 240 are formed. In addition, directions in which the coils are wound in the plurality of auxiliary slots 222 intersect with each other and are repeated.

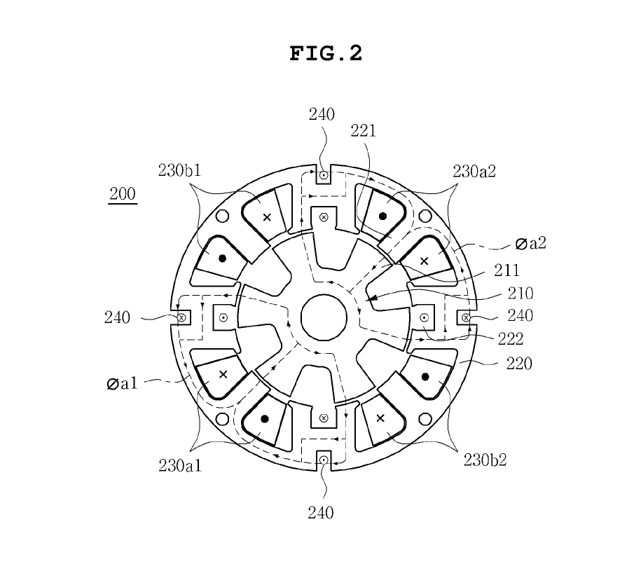

Through the above-mentioned configuration, as shown in FIG. 2, the electromagnets 240 generate magnetic force in a direction corresponding to those of magnetic fluxes generated in the phase windings.

FIG. 1 shows a two-phase switched reluctance motor in which six salient poles 211 of the rotor are formed at equipitch in the circumferential direction of the rotor and four salient poles 221 of the stator body 220 are formed at equipitch in the circumferential direction of the rotor. In addition, each of the coils is concentratedly wound around four salient poles 221, such that two-phase phase windings 230a1, 230a2, 230b1, and 230b2 having an A phase and a B phase are formed. In addition, four auxiliary slots 222 are formed between the salient poles.

As described above, the switched reluctance motor 200 shown in FIG. 1 is the two-phase switched reluctance motor. Therefore, an even-phase switched reluctance motor corresponding to 2n (n indicates a positive integer) is configured so that directions of magnetic fluxes by the electromagnet and excitation of the phase winding interact with each other as in a switched reluctance motor shown in FIG. 2.

FIG. 2 is a schematic use state view showing magnetic flux distribution at the time of excitation of a first-phase winding in the switched reluctance motor shown in FIG. 1.

As shown, in the switched reluctance motor 200, when A phase windings 230a1 and 230a2, which is a first phase, of the phase windings have a current applied thereto to be excited, magnet fluxes are generated. More specifically, magnetic fluxes of the A phase windings 230a1 and 230a2 and magnetic fluxes by magnetic force by the electromagnets 240 (Φa1 and Φa2) are generated. Here, directions of the magnetic force of the electromagnets 240 correspond to those of the magnetic fluxes generated in the A phase windings 230a1 and 230a2, such that torque density is improved. In addition, an intersection line is not generated in the magnetic fluxes at any position of the stator, such that core loss is reduced. That is, the magnetic flux has a short path, such that an inductance increases. Furthermore, due to the electromagnet, a magnetic flux amount increases and attractive force is improved, such that the rotor rotates.

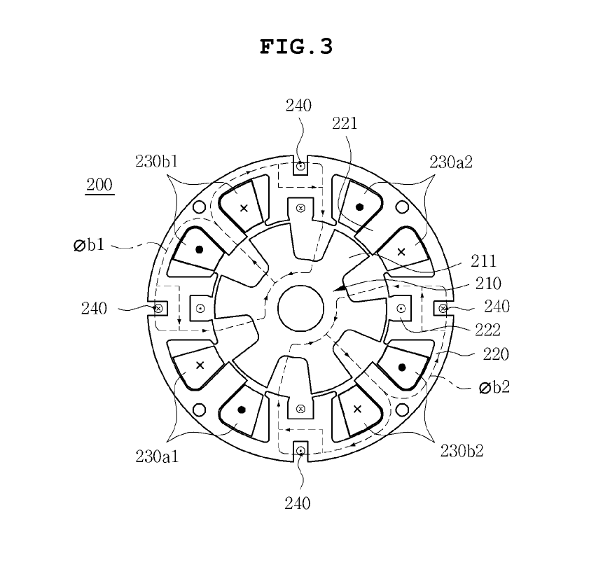

FIG. 3 is a schematic use state view showing magnetic flux distribution at the time of excitation of a second-phase winding in the switched reluctance motor shown in FIG. 1. As shown, in the switched reluctance motor 200, when B phase windings 230b1 and 230b2, which is a second phase, of the phase windings have a current applied thereto to be excited, magnetic fluxes (Φb1 and Φb2) are generated. In this case, directions of the magnetic force of the electromagnets 240 correspond to those of the magnetic fluxes generated in the B phase windings 230b1 and 230b2, such that torque density is improved.

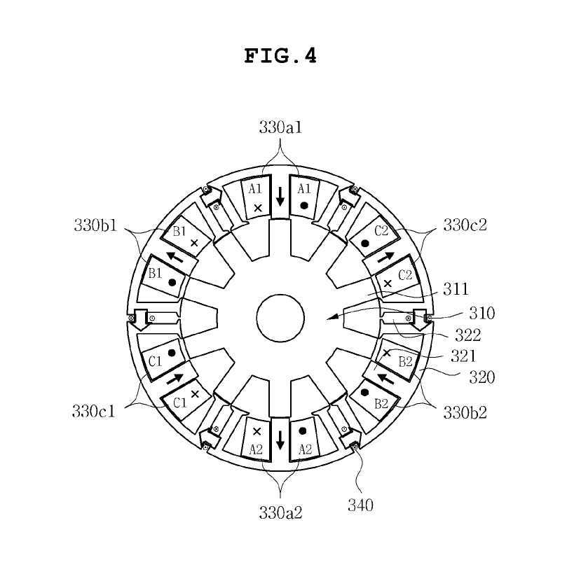

FIG. 4 is a schematic configuration view of a switched reluctance motor according to a second preferred embodiment of the present invention. As shown, the switched reluctance motor 300 is implemented as a three-phase switched reluctance motor, in contrast with the switched reluctance motor 200 according to the first preferred embodiment of the present invention shown in FIG. 1.

To this end, the switched reluctance motor 300 is configured to include a rotor 310 and a stator including a stator body 320, phase windings 330, and electromagnets 340.

More specifically, the rotor 310 is rotatably disposed in an inner side of the stator and is implemented as a salient pole type rotor including a plurality of salient poles 311 formed at an outer peripheral portion thereof in a radial direction. In addition, ten salient poles 311 of the rotor are formed at equipitch in a circumferential direction of the rotor.

Further, six salient poles 321 of the stator body 320 are formed, and each of the coils is concentratedly wound around six salient poles 321, such that three-phase phase windings 330a1, 330a2, 330b1, 330b2, 330c1, and 330c2 having a U phase, a V phase, and a W phase are formed.

In addition, six auxiliary slots 322 are formed between the salient poles 321, the coils are wound in the auxiliary slots 322, such that the electromagnets 340 are formed, and the electromagnets 340 are disposed so that magnetic force is generated in a direction corresponding to those in magnetic fluxes generated in the phase windings 330a1, 330a2, 330b1, 330b2, 330c1, and 330c2.

The switched reluctance motor 300 having the above-mentioned configuration allows directions of the magnetic fluxes to intersect with each other in a sequence of a U phase winding 330a1, a V phase winding 330b1, a W phase winding 330c1, a U phase winding 330a2, a V phase winding 330b2, and a W phase winding 330c2, such that an intersection line is not generated in the magnetic fluxes at any position, unlike the two-phase switched reluctance motor 200. In addition, the electromagnets 340 are mounted so that the magnetic force is generated in a direction corresponding to those of the magnetic fluxes of the phase windings 330a1, 330a2, 330b1, 330b2, 330c1, and 330c2. Therefore, the magnetic force is generated in a direction as shown by an arrow, thereby making it possible to improve torque density.

As described above, the switched reluctance motor 300 shown in FIG. 4 is the three-phase switched motor. Therefore, an odd-phase switched reluctance motor may be designed so that directions of the magnets and the magnetic fluxes are determined as in the switched reluctance motor 300 shown in FIG. 4.

Through the above-mentioned configuration, the intersection line is not generated in the magnetic fluxes in the stator by the electromagnet, such that the core loss may be reduced and the torque density may be improved.

According to the preferred embodiment of the present invention, it is possible to provide a switched reluctance motor in which the plurality of phase windings are formed by winding the coils around the salient poles of the stator and the electromagnets are formed by winding the coils in the auxiliary slots between the phase windings, wherein magnetic fluxes generated due to excitation of the phase windings interact with magnetic force generated from the electromagnets, such that a magnetic flux amount may increase and torque density may be improved, and an intersection line is not generated in the magnetic fluxes generated due to the excitation of the phase windings, such that core loss may be reduced.

Although the preferred embodiments of the present invention have been disclosed for illustrative purposes, they are for specifically explaining the present invention and thus a switched reluctance motor according to the present invention is not limited thereto, but those skilled in the art will appreciate that various modifications, additions and substitutions are possible, without departing from the scope and spirit of the invention as disclosed in the accompanying claims

Accordingly, any and all modifications, variations or equivalent arrangements should be considered to be within the scope of the invention, and the detailed scope of the invention will be disclosed by the accompanying claims

What is claimed is:

1. A switched reluctance motor comprising:
a salient pole type rotor provided with a plurality of salient poles; and
a stator including a stator body provided with a plurality of salient poles facing the rotor and a plurality of auxiliary slots disposed between the salient poles, a plurality of phase windings formed by winding coils around the salient poles, and a plurality of electromagnets formed by winding coils in the auxiliary slots.

2. The switched reluctance motor as set forth in claim 1, wherein the plurality of salient poles formed in the stator are protruded inwardly in a radial direction so as to face the rotor and are disposed at equipitch in a circumferential direction.

3. The switched reluctance motor as set forth in claim 1, wherein the plurality of auxiliary slots are slots formed to be directed from an inner diameter of the stator body toward an outer diameter thereof or from the outer diameter thereof toward the inner diameter thereof.

4. The switched reluctance motor as set forth in claim 3, wherein directions in which the coils are wound in the plurality of auxiliary slots intersect with each other and are repeated.

5. The switched reluctance motor as set forth in claim 1, wherein the electromagnets are disposed so that magnetic force is generated in a direction corresponding to those of magnetic fluxes generated in the phase windings.

6. The switched reluctance motor as set forth in claim 1, wherein directions in which the coils are wound around the plurality of salient poles of the stator intersect with each other and are repeated.

7. The switched reluctance motor as set forth in claim 1, wherein an intersection line is not generated in magnetic fluxes generated due to excitation of the phase windings.

8. The switched reluctance motor as set forth in claim 1, wherein six salient poles of the rotor are formed at equipitch in a circumferential direction of the rotor, four salient poles of the stator body are formed at equipitch in the circumferential direction of the rotor body, the phase winding is formed as a two-phase winding formed by winding the coils around the salient poles, and four auxiliary slots are formed between the salient poles.

9. The switched reluctance motor as set forth in claim 1, wherein ten salient poles of the rotor are formed at equipitch in a circumferential direction of the rotor, six salient poles of the stator body corresponding to the salient poles of the rotor are formed at equipitch in a circumferential direction of the stator body, the phase winding is formed as a three-phase winding formed by winding the coils around the salient poles, and six auxiliary slots are formed between the salient poles.
